(19) United States
(12) Patent Application Publication
(10) Pub. No.: US 2006/0038028 A1
(43) Pub. Date: Feb. 23, 2006

(54) Personal hydration system

(76) Inventors: Jeffrey F. Miller, Kyle, TX (US); Jeri A. Miller, Kyle, TX (US)

Correspondence Address: MICHAEL O. SCHEINBERG, P.O. BOX 164140, AUSTIN, TX, 78716-4140, US

(21) Appl. No.: 11/017,320

(22) Filed: Dec. 20, 2004

Related U.S. Application Data
(60) Provisional application No. 60/605,881, filed on Aug. 31, 2004.
(60) Provisional application No. 60/603,846, filed on Aug. 23, 2004.
(60) Provisional application No. 60/603,850, filed on Aug. 23, 2004.

(51) Int. Cl. B05B 12/14

(52) U.S. Cl. 239/24

(57) ABSTRACT

A valve system having a flexible reservoir includes a first opening for filling the reservoir, a second opening from which a drinking tube extends, and a third opening for releasing air from the reservoir. By releasing air from the reservoir, the hydration system reduces or eliminates sloshing noises during activity. While the user is in motion, improving the function and enjoyment of the personal hydration system

### RELATED APPLICATIONS

This application claims priority from U.S. Provisional Pat. App. 60/605,881 filed 31 Aug. 2004, U.S. Provisional Pat. App. 60/603,846, filed Aug. 23, 2004, and U.S. Provisional Pat. App. 60/603,850, filed Aug. 24, 2004, all of which are hereby incorporated by reference.

### TECHNICAL FIELD OF THE INVENTION

The present invention relates to hydration systems, and in particular, to a hydration system having reduced noise and fluid motion within a reservoir.

### BACKGROUND OF THE INVENTION

When people exercise or participate in vigorous physical activity, they need a supply to fluids to keep from becoming dehydrated. People use many different types of containers to keep fluids nearby, including rigid containers, such as canteens; semi rigid containers, such as plastic bottles; and flexible, bladder systems such as botas and modem hydration systems.

Sophisticated modem hydration systems typically include a flexible reservoir, supported in a backpack or fanny pack worn by a user. A drinking tube extends from an opening in the reservoir and includes near its end a mouth-operated valve. The drinking tube can be clipped onto the users clothing or equipment to keep the valve in a position near the user's mouth. When the user wants to drink, he or she takes the valve into his or her mouth, opens the valve, and drinks. Such personal hydration systems are used by bicyclists, runners, hikers, and others to provide water or other potable fluids.

U.S. Pat. No. 5,816,457 to Croft; U.S. Pat. No. 6,666,360 to Swank; U.S. Pat. No. 6,675,998 to Foresman; and U.S. Pat. No. 6,722,533 to Skillem all show examples of personal hydration systems that allow athletes to get hydration hands free. The patents listed above describe similar systems, with various improvements to the hose, mouthpiece, and exterior design of the reservoir or bladder.

Because hydration systems tend to be used during physical activity, the systems are subject to acceleration as the wearer moves, and water in the reservoirs tends to slosh around, which makes noise. Such noise is often a nuisance and distracts from the pleasure of the activity. In some applications, such as in the military, such noise is more than a nuisance; it can alert an enemy to a soldier's location and put him or her at risk.

### SUMMARY OF THE INVENTION

An object of the invention is to provide a hydration system with reduced noise.

This invention relates to an improved hydration system. The invention facilitates removing air from a flexible reservoir in a hydration system. By removing the air, the noise of the liquid hydration system during activity is greatly reduced or eliminated. The invention uses an opening in the reservoir to remove trapped gas, the opening being different from the opening used to fill the reservoir and from the opening through which the user drinks.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be relized by those skilled in the art that such equivalent constructions do not depart from the sprit and scope of the invention as set forth in the appended claims.

### BRIEF DESCRIPTION OF THE DRAWINGS

For a more through understanding of the present invention, and advantages therefore, reference is now made to the following description taken in conjunction with the accompanying drawings, in which:

FIG. 1 is a front perspective view of a hydration reservoir showing a valve installed on the reservoir.

FIG. 2 is a perspective front view of the valve of FIG. 1.

FIG. 3 is a right-side perspective view of the hydration system of FIG. 1.

FIG. 4A shows a reservoir filler cap used in an embodiment of the invention, and FIG. 4B shows a filler cap ring, onto which the filler cap is screwed.

FIG. 5 is a flowchart showing a method of filling a hydration system of the present invention.

FIG. 6 is a top view of a filler cap that can be used with an embodiment of the present invention.

FIG. 7 is a front view of the filler cap of FIG. 6.

FIG. 8 is bottom view of the filler cap. of FIG. 6.

### DETAILED DESCRIPTION OF PREFERRED EMBODIMENTS

The invention is an improved hydration system and is particularly applicable to personal hydration systems for supplying a potable liquid to persons that hike, bike, run or participate in other outdoor sports and activities, including the military and community servants.

Whereas prior art flexible hydration systems include a first closeable opening for filling the reservoir and a second opening for attaching a drinking tube, a preferred embodiment of the invention includes a third opening that can be opened to allow gas to be removed from the reservoir, and then closed to prevent liquid from escaping.

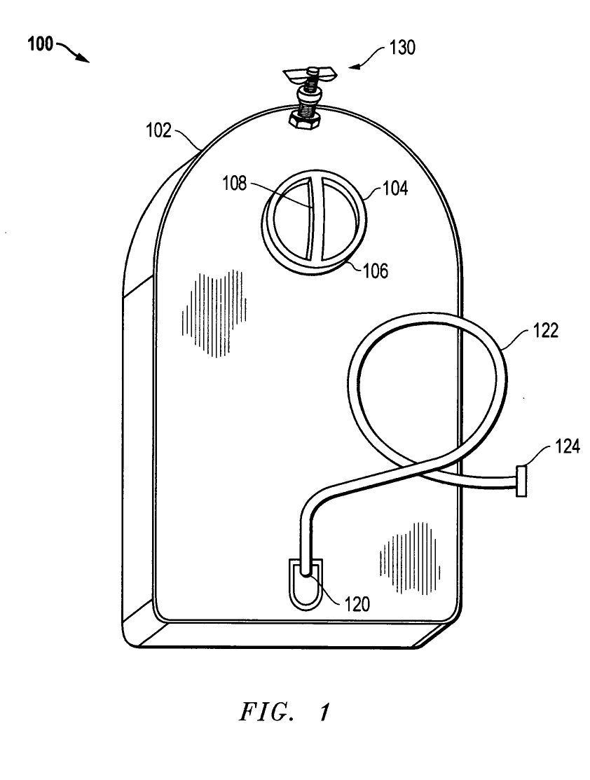

FIG. 1 shows a personal hydration system 100 that is an embodiment of the present invention. Hydration system 100 includes a reservoir 102 comprised of a flexible, liquid proof material and having a first closeable opening 104 for filling reservoir 102 with water or other liquid. A filler cap ring (not shown) has a flange for sealing against reservoir 102 and a threaded portion for mating with a filler cap 106. Filler cap 106 preferably has a bar 108 to facilitate screwing filler cap 106 onto and off of the filler cap ring to open and close first closeable opening 104. Other types of closure mechanisms, such as non-threaded filler caps, could also be used. The cap should lock in place, such as by mechanical or frictional means, after it is closed so that liquid does not leak. Opening 104 is preferable sufficiently large to permit rapid filling, emptying, and cleaning of reservoir 102.

Hydration system 100 includes a second opening 120 from which a drinking tube 122 extends. Drinking tube 122 includes a mouth-operated valve 124 near its distal end and a clip (not shown) for attaching the tube to the user's clothing or equipment to keep valve 124 convenient to the user's mouth. The user can drink from the liquid stored in the reservoir without using his or her hands by putting valve 124 into his or her mouth, opening the valve, and sucking in the liquid.

Hydration system 100 also includes a third opening that allows a user to remove some or all of the air from reservoir 102 after a liquid is poured in and filler cap 106 secured onto the filler cap ring to seal the first closeable opening. The removal of the air from the reservoir eliminates or considerably reduces the noise and motion and of the liquid inside the reservoir. A gas escape valve 130 opens to allow air to be removed and closes to keep the fluid within the reservoir.

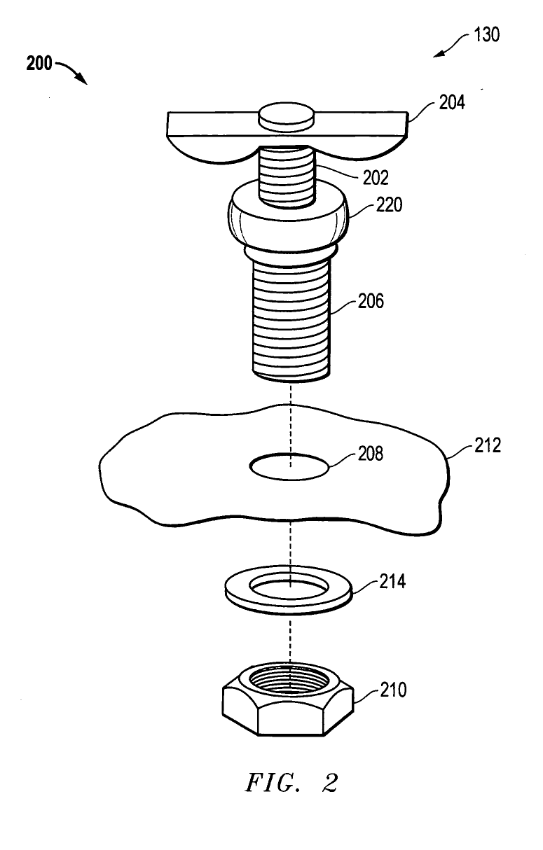

FIG. 2 shows a detailed view of gas escape valve 130. When opened, valve 130 allows gas to exit reservoir 102, and when closed, valve 130 prevents liquid from passing. Valve 130 includes a valve body 200 from which extends a rotatable stem 202 having a handle 204 by which a user can rotate stem 202. As a user rotates stem 202 clockwise or counterclockwise, gas escape valve 130 opens or closes. There are many known mechanisms by which gas escape valve 130 could operate. For example, stem 202 could have a threaded portion that mates with complementary threads within valve body 200. As stem 202 rotates, it moves longitudinally within valve body 200 to plug or unplug an opening in reservoir 102. In other embodiments, for example, stem 202 could rotate to cover and uncover an opening without moving longitudinally.

body 200 includes an external threaded portion 206 that is inserted into a hole 208 in reservoir 102. A nut 210 positioned inside reservoir 102 is threaded onto threaded portion 206 and traps a portion of flexible reservoir material 212 between a washer 214 and a flat portion 220 of valve body 200, thereby attaching valve 130 to reservoir 102 so as to prevent liquid leaking out at the attachment point of valve 130. An additional washer can be used on the outside of reservoir 102. and a sealant can be used at the point of valve attachment to ensure a liquid proof seal where valve 130 is attached to reservoir 102.

The invention is not limited to any particular type of gas escape mechanism. For example, an embodiment could use a valve, a cap, or other device that a user could open to allow gas to escape and close to prevent liquid from escaping. For example, a cap, such as a threaded or non-threaded cap, could be used as a gas escape means. The cap should lock in place, such as by mechanical or frictional means, so that it remains water tight after it is closed. One could use a “normally closed” type valve, that is, a valve that opens when the user applies a force, such as pushing or squeezing, and then returns to the closed position when the force is released. Some of the types of valves that could be used include, for example, gate valves, plug valves, globe valves, ball valves, and butterfly valves. A push button valve could be used. Skilled persons will be able to select or design a suitable valve or other mechanism.

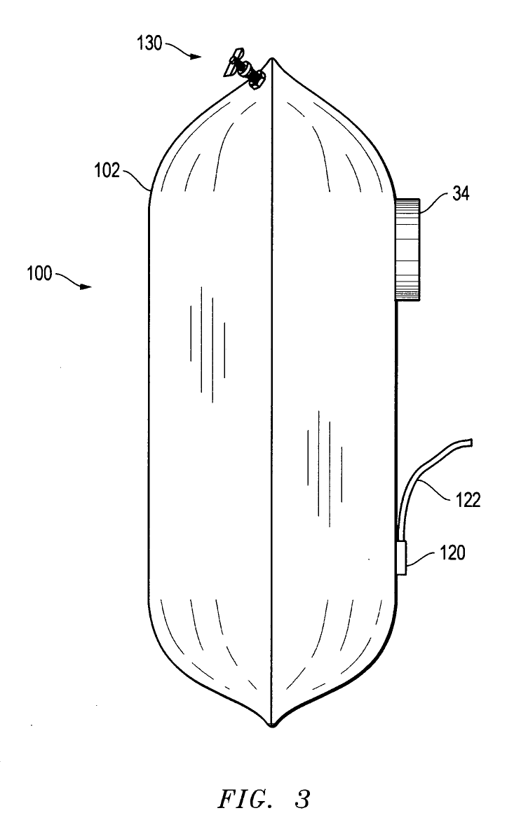

Valve 130 is preferably positioned on reservoir 102 in a position that facilitates removal air or other gas from reservoir 102. For example, FIG. 3 shows valve 130 positioned near the top of reservoir 102, so that air that rises to the top can readily escape. Valve 130 or other mechanism for allowing gas to escape and retaining liquid can be positioned directly on reservoir 102, or can be indirectly in reservoir 102, for example, on the filler cap, at the base or elsewhere along the drink tube, or elsewhere.

FIGS. 4A and 4B show portions of another hydration system 400. FIG. 4A shows a filler cap 430 and FIG. 4B shows a filler cap ring 404 that is attached to a reservoir and that accepts filler cap 430. Filler cap ring 404 includes external threads 406 and a flange 408 positioned within reservoir 422, with reservoir material 410 being sealed against flange 408 in a waterproof manner. Filler cap 430 screws onto ring 404 to close the opening and unscrews to allow filling of the reservoir.

A gas release valve 440 is positioned on filler cap 430. Filler cap 430 could include one or more passages 442 that are normally blocked by a valve member 444. When a user presses on a spring-loaded or otherwise biased valve button 446, a valve member 444 is displaced, allowing gas to flow through passages 442. A hydration system 400 thus includes a first opening for filing the reservoir, a second opening from which a drinking tube extends, and a third opening to allow gas to escape, the third opening being positioned on the filler cap that closes the first opening. The third opening does not need to be a separate hole in the reservoir itself, but can access the gas in the reservoir through another opening. The filler cap 430 with valve 440 can be mounted onto a conventional hydration system, thereby retrofitting an existing system to incorporate the benefits of the invention by reducing noise.

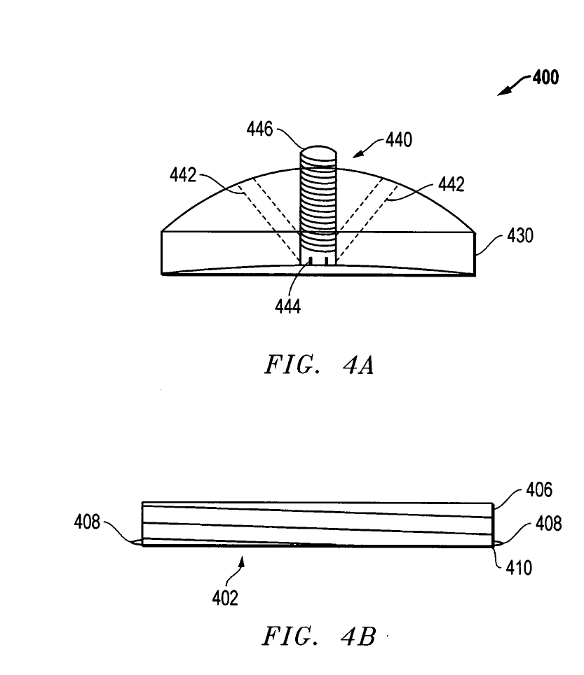

FIG. 5 is a flowchart showing a preferred method of filling a hydration system. In step 502, the user removes the reservoir filler cap. In step 504, a user fills the flexible reservoir with a liquid. In step 506, the user replaces the filler cap. In step 510, the user orients the reservoir so that the gas escape valve is at approximately the highest point, so that gas trapped in reservoir will accumulate near the escape valve. For example, in hydration system 102 of FIGS. 1 and 3, the reservoir is laid on its front side or held vertically. In step 514, the user opens the gas escape valve. In step 516, the user gently squeezes the flexible reservoir to force all or most of the gas within the reservoir out through the gas escape valve, and then in step 520 closes the gas escape valve after the gas is expelled. The hydration system can then be placed in step 522 into an optional backpack or other carrier for mounting on a user or on equipment. In some embodiments, the hydration system can include a means for carrying the system, such as a handle or straps, mounted directed onto the reservoir.

The hydration system is now ready to use, and the absence of trapped gas will reduce the noise and motion of the water significantly. While the user is in motion, either biking, hiking, running or some other type of sport or activity, even walking, the invention will restrict the motion of the liquid within the reservoir which in turn reduces the noise of the liquid within the reservoir and the motion of the liquid against the users body, thereby allowing a user to enjoy his or her surroundings while doing sports, and making the military “stealthier” in its missions.

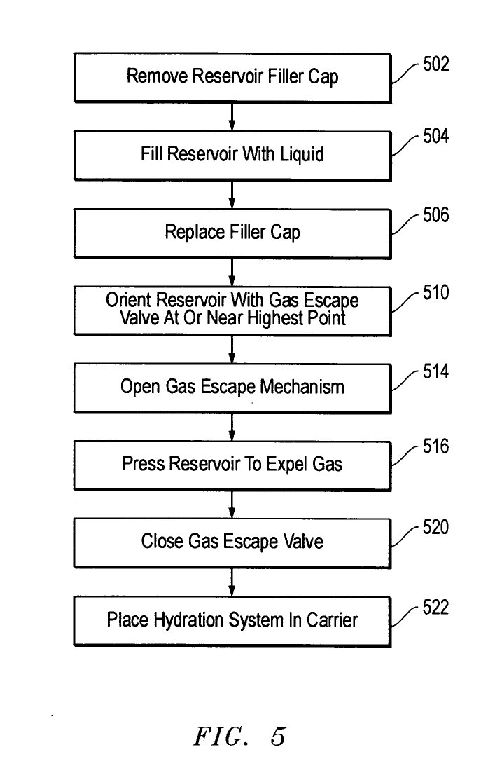

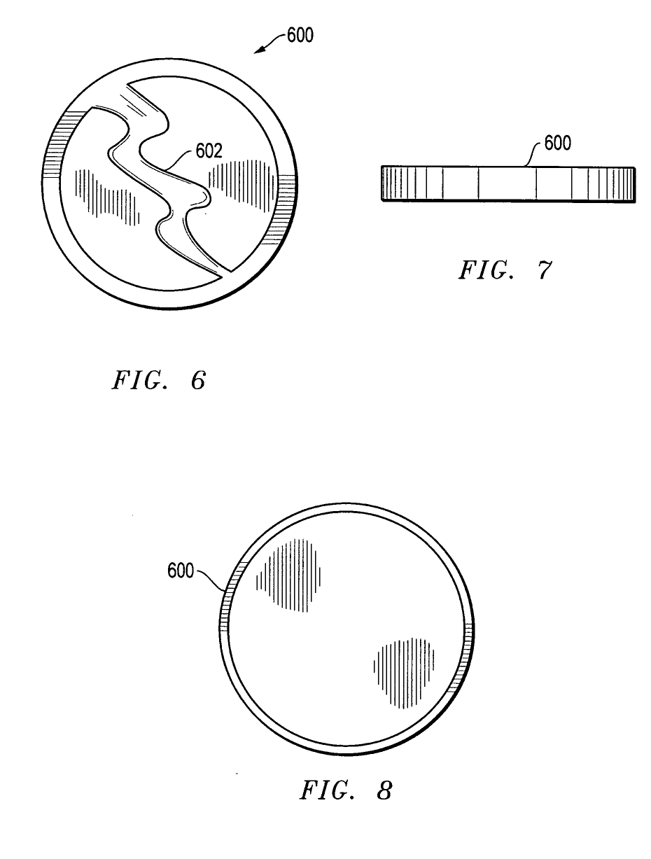

FIG. 6 shows a filler cap 600 having an ornamental handle for screwing and unscrewing the filler cap 600 onto or off of the reservoir. FIG. 7 shows a side view of the filler cap 600. The front, back and sides views of filler cap 600 are identical. FIG. 8 shows a bottom view of the filler cap of FIG. 6.

A hydration system can also contain baffles inside the reservoir, either together with the gas release capability or separately. Baffle systems are described, for example, in U.S. Prov. Pat. Apps. No. 60/603846 and 60/603850, both filed Aug. 23, 2004.

The closeable opening through which gas escapes is preferably significantly smaller that the first opening, which is used to fill the reservoir. For example, the opening is preferably less than one tenth the area of the filler opening, and more preferably less than one twenty fifth the area of the first opening. The closeable opening through which gas escapes preferably does not have a tube, such as a drinking tube or a filler tube attached.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A hydration system, comprising:
a flexible reservoir for storing a liquid;
a first closable opening in the flexible reservoir for filling or emptying the reservoir;
a second opening in the reservoir;
a drinking tube connected to the second opening,
a drinking valve positioned toward the end of the drinking tube, the valve adapted to be opened by a user's mouth for drinking from the tube; and
a third closeable opening in the reservoir, the third opening being openable to allow gas to exit the reservoir and being closeable to prevent liquid from leaving the reservoir after the gas is removed.

2. The hydration system of claim 1 in which the third closeable opening includes a gas release valve that can open and close the third opening.

3. The hydration system of claim 2 in which the gas release valve is a gate valve, a plug valve, a globe valve, a ball valve, or a butterfly valve.

4. The hydration system of claim 2 in which the gas release valve is a push button valve.

5. The hydration system of claim 1 in which the first closeable opening includes a threaded cap for closing the opening.

6. The hydration system of claim 1 in which the first closeable opening includes a non-threaded cap for closing the opening.

7. The hydration system of claim 1 in which the third closeable opening includes a threaded portion and a threaded cap for securing onto the threaded portion.

8. The hydration system of claim 1 in which the third closeable opening includes cap that locks in place without threads.

9. The hydration system of claim 1 in which the first closeable opening includes a filler cap and in which the third closeable opening is positioned on the filler cap.

10. The hydration system of claim 1 in which the third closeable includes a valve of the normally closed type, the valve being openable by the user to allow gas to escape from the reservoir.

11. A method of filling a hydration system, the hydration system including a flexible reservoir, a first closeable opening for filing the reservoir, and a drinking tube extending from a second opening;
opening the first closeable opening;
filling the hydration system through the first fillable opening;
closing the first closeable opening;
opening a third closeable opening, the third closeable opening being different from the first closeable opening and not part of the drinking tube;
removing air from the reservoir through the third closeable opening;
closing the third closeable opening.

12. The method of claim 11 in which opening a third closeable opening includes opening a valve associated with the third closeable opening and in which closing the third closeable opening includes closing the valve.

13. The method of claim 11 in which opening a third closeable opening includes removing a cap that is not attached using threads.

14. The method of claim 12 in which opening a third closeable opening including opening a gate valve, a plug valve, a globe valve, a ball valve, or a butterfly valve.

15. The method of claim 11 in which opening a third closeable opening includes removing a screw cap valve associated with the third closeable opening and in which closing the third closeable opening includes replacing the screw cap.

16. The method of claim 12 in which opening a third closeable opening including opening a push button valve.

17. The method of claim 11 in which removing air from the reservoir through the third closeable opening including pressing the flexible reservoir to force air out of the third closeable opening.

18. A filler cap for a hydration system having a flexible reservoir, the filler cap allowing the reservoir to be filled with a liquid or emptied, comprising:
a filler cap body fitted to an opening in the reservoir; and
a closeable opening on the filler cap body, the closeable opening being openable by a user to release air from the reservoir and closeable to prevent liquid from escaping the reservoir.

19. The filler cap of claim 18 in which the closeable opening includes a valve.

20. The filler cap of claim 19 in which the valve is of the normally closed type, the valve being openable by the user to allow air to escape the reservoir.
